(19) United States
(12) Patent Application Publication
(10) Pub. No.: US 2005/0015809 A1
(43) Pub. Date: Jan. 20, 2005

(54) Method and apparatus for picture sharing over cable and other consumer subscribed television networks

(76) Inventor: Donald R.M. Boys, Bella Vista, CA (US)

Correspondence Address: CENTRAL COAST PATENT AGENCY, PO BOX 187, AROMAS, CA, 95004, US

(21) Appl. No.: 10/621,781

(22) Filed: Jul. 16, 2003

(51) Int. Cl. H04N 7/173

(52) U.S. Cl. 725/105

(57) ABSTRACT

A system for sharing a display transmission sourced from a media capture device over a television network has a source node connected to the network, the source node including the media capture device storing the content for transmission; at least one receiving node connected to the network; a central server for brokering the transmission; and a transmission splitting module integrated into the display path and into the back channel transmission path of the source node for rendering a second version of the display transmission. The display transmission is ordered from the source node and executed from the media capture device connected to the source node whereupon the transmission splitting module diverts a version of the display to be sent to the central server over a back channel of the system, the central server then ordering broadcast of the display transmission to the at least one receiving node over the network.

### CROSS-REFERENCE TO RELATED DOCUMENTS

The present invention has reference to a disclosure document, Ser. No. 514,245 filed under the Document Disclosure program on Jun. 25, 2002 entitled “Method and Apparatus for Sharing Pictures Over a Cable Service from Television to Television”

### FIELD OF THE INVENTION

The present invention is in the field of television content delivery over cable and other television networks and pertains particularly to methods and apparatus for user sharing of digital photographs over subscriber cable and satellite television networks.

### BACKGROUND OF THE INVENTION

In the field of television, a most popular venue for content delivery to consumers is cable network television service and competing satellite network television service. An ever increasing number of television viewers now have subscriber-based cable services or satellite-based television services. Both delivery methods differ somewhat in the technology used to actually deliver content.

In a cable service, content is received at the point of use by, most commonly, underground cables including state-of-art fiber optics cable. In a cable network content is delivered to subscribers in a digital form to be received at a set top box adapted for the purpose, which is connected to the user's television. There are basic channels that all subscribers of a given area of the network receive and there are additional channels, termed, pay-per-view channels that allow subscribers to order offered content on-demand based on personal identification and credit history and then view that content once an order has been confirmed.

Satellite services are organized in similar fashion having dedicated channels for content delivery, and a channel for receiving user orders for pay per-view services. Most satellite systems and some cable systems use the telephone as a back channel or an “order channel” and require a telephone hook-up to the receiver box so that customer orders are received by the company hosting the service. Such orders can be placed without interrupting the user's normal telephone service. Other systems provide a back channel within the cable itself as a dedicated allotment of bandwidth available for receiving orders from the customers. In most cases the bandwidth schemes for delivery of content and for receiving customer input are programmable in terms of the amount of bandwidth allotted for each way of bi-directional data flow through the cables.

A very popular activity among computer users is sharing photographs with other users over a digital network such as the Internet network. If a user desires to share photographs taken with a digital camera with other persons such as family and friends, for example, he or she must connect the device bearing the picture data to a computer system using a USB or other cable, or wireless transport mechanism and upload the desired pictures into the computer. The pictures then must be included in an e-mail message or other digital transport mechanism addressed to the persons selected by the user as recipients of the pictures. An Internet connection and special software is typically required to enable this process and the pictures are downloaded and viewed at the other end by user operating compatible computer equipment and software having network connectivity.

There are emerging problems and concerns related to picture sharing over the Internet or other networks. One of these concerns is the emergence of new computer viruses that can invade customer accounts and corrupt pictures being transported. Another limitation exists in that not all of a user's friends and family have computer systems, compatible software, and ISP subscriptions to the Internet. Still another limitation is the amount of work one has to perform, measured in the number of steps, in order to enable transport of the pictures over a computer network.

It is well known that in addition to television subscriber services and equipment, televisions currently on the market have input ports for receiving input from a wide variety of entertainment systems and media capture devices. For example, a user can connect a digital camera, including any digital movie/picture camera directly to a VCR, set-top cable or satellite receiver, or directly to the television in order to view any digital photographs or movies that may be stored in the cameras memory. An output cable is all that is required to enable the process.

It has become extremely popular to connect such devices to a television system in order to view pictures on a much larger screen (television) than would normally be possible, for example, on a computer monitor. Cable and satellite-based television networks are virus free mediums. Likewise, the number of persons owning a television with a cable or satellite system approaches 100 percent wherein it is very likely that all of the family and friends of any user of a cable or satellite television system also has similar access.

What is clearly needed in the art is a method and apparatus that enables picture sharing over cable and satellite television networks between users connected to the network. A system such as this would enable an alternate medium for a very popular pastime without subjecting users to common computer dangers like viruses, and incompatibility of components, services, or software.

### SUMMARY OF THE INVENTION

In a preferred embodiment of the invention a system for sharing a content display transmission sourced from a media capture device over a television network is provided comprising a source node connected to the network, the source node including the media capture device storing the content for transmission; at least one receiving node connected to the network; a central server for brokering the transmission; and a transmission splitting module integrated into the display path and into the back channel transmission path of the source node for rendering a second version of the display transmission. The system is characterized in that the display transmission is configured on the source node and physically executed from the media capture device connected to the source node, the device containing the content for display and wherein the transmission splitting module diverts a version of the display to be sent to the central server over a back channel of the system, the central server then ordering broadcast of the display transmission to the at least one receiving node over the network.

Also in a preferred embodiment the television network is a cable network. Also in a preferred embodiment the television network may be a satellite network. In some embodiments the transmission is a display transmission of a series of picture files organized in the form of a picture slide show. In some other embodiments transmission is a display transmission of a series of video frames organized as a compressed video. In some cases the source node including the media capture device and the at least one receiving nodes further comprise at least a television and a set-top-box.

In still other embodiments the network is a cable network and the back channel is a data path in the carrier cable, and in others the network is a satellite network and the back channel is a telephone line. In some cases central server contains a list server for identifying subscribers and validating those subscribers for receiving a transmission. In yet other embodiments the central server is a modified pay-per-view server wherein the transmissions orchestrated there through are directed to subscribers over a special dedicated pay-per-view channel adapted for the purpose, and in still others the central server has notification software and causes alerts to be sent to receiving nodes over the network, the alerts notifying alerting subscribers of pending transmissions.

In yet further embodiments of the invention the central server has access to recording software for recording a display transmission and storing it for later broadcasting. In other embodiments a user operating the source node via a remote control may configure a transmission for execution including identification of intended recipients. In further cases a user operating the source node may configure a transmission for execution including identification of intended recipients using a telephone. In still further cases the transmission display splitting module is integrated into the set-top-box, and in still further cases the transmission display module is a separate unit and cabled to the set-to-box and cabled into the back channel.

In another aspect of the invention a transmission display splitting module is provided comprising a controller interfaced to a remote control device; a buffer for buffering data; a firmware for mirroring data; and a splitter for directing mirrored data on two paths. This module is characterized in that the module causes an identical version of a display transmission sourced from a media capture device connected to a node on a television network to be sent over a back channel of the node to a central server to be redirected to display on a receiving node connected to the network.

In some preferred embodiments the module is integrated into a set-top-box connected to the network. In other preferred embodiments the module is separate and cabled to the set-top-box for local display and to the back channel. In still others the network is a cable network and the back channel is a data channel in a carrier cable. In other embodiments the network is a satellite network and the back channel is a telephone line. In some cases the module may be powered by a separate AC outlet or by AC through the set-top-box.

In yet another aspect of the invention, on a television network, a method for causing a display transmission sourced from a media capture device connected to a source node to be shared with a designated receiving node the shared version sent from the source node over a system back channel to a central server and then over network paths to the receiving node, the source and receiving node both connected to the television network is provided, comprising (a) connecting the media capture device to a data input of the source node, (b) pre-configuring and ordering the sharing session; and (c) executing the display transmission from the media capture device.

In some preferred embodiments of the method in step (a) the media capture device is a digital camera. In some other preferred embodiments in step (a) the media capture device is a video capture device.

In some embodiments in step (b) pre-configuring and ordering is performed by a remote control, while in others in step (b) pre-configuring and ordering is performed through a telephone.

### BRIEF DESCRIPTION OF THE DRAWING FIGURES

FIG. 1 is an architectural overview of a television cable network adapted for picture sharing according to an embodiment of the present invention.

FIG. 2 is an architectural overview of a televising satellite network adapted for picture sharing according to an embodiment of the present invention.

FIG. 3 is a block diagram illustrating a picture-sharing module according to an embodiment of the present invention.

FIG. 4 is a use-case diagram illustrating steps for picture sharing according to an embodiment of the present invention.

### DESCRIPTION OF THE PREFERRED EMBODIMENTS

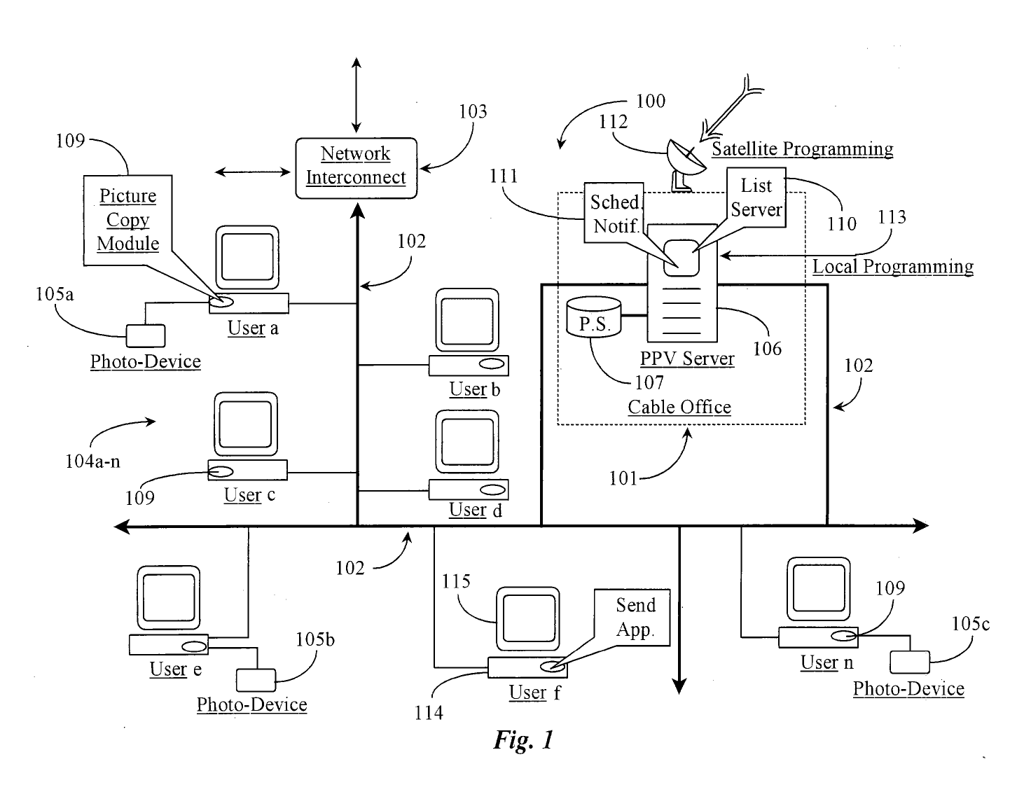

FIG. 1 is an architectural overview of a television cable network 100 adapted for picture sharing according to an embodiment of the present invention. Network 100 represents a geographic portion of a cable television network. Network 100 comprises a cable office facility 101 and a plurality of subscribing users illustrated herein as users 104a-n.

Cable office 101 represents a service provider that coordinates cable services and handles subscription, maintenance, and content delivery services. In this example, a central office is illustrated however in some embodiments there may be multiple separate facilities involved in service provision. The inventor illustrates one such facility for purposes of explanation of the invention.

Office 101 has at least one server 106 provided therein and adapted among other possible functions as a picture share server according to a preferred aspect of the present invention. In this example, server 106 also represents a Pay-per-view (PPV) server that coordinates content that is subscribed to and/or ordered for viewing by any one or more of subscribed users 104a-n.

Server 106 has delivery access to network cable lines collectively referred to herein as cable lines 102 that make up physical network 100. Cable lines 102 can be fiber optic, coaxial, or any other suitable type of cabling used in such cable networks. Other network components such as relays, amplifiers and other such inline equipment are not illustrated but are assumed present.

Each user 104a-n is illustrated as connected to network 100 via an access line branching off of main line 102 and into customer premise equipment illustrated herein as a plurality of set-top boxes 114, which are distributed one each per user 104a-n and are essentially identical to one another. Each set-top box 114 has connection to a cable-ready television illustrated herein as a television 115 assumed present within each user location. In some cases, any particular user 104a-n may have more than one set-top box 114 and television display 115 connected to network 100 and adapted for receiving cable services. The inventor illustrates one CPE system per each user and deems the illustration sufficient for the purpose of explanation.

As is generally known in the art of cable services, users 104a-n are typically subscribed to service packages that detail the type and availability of content according to a particular subscription option. Generally, the Pay-per-view services are obtainable at any time a user whishes by placing an order for a particular event through a cable back channel, or telephone channel in some systems. Users 104a-n are identified on the network primarily by telephone number for billing and system ID number for network identification. In fact, the users telephone number is sufficient for user identification on the network.

In an embodiment wherein server 106 is also a content delivery server, it is noted herein that typically local programming is provided as well as regional programming sourced from far-off facilities. In this example, local programming source or “head-end” is represented herein by trunk 113 labeled Local Programming. Regional content coming into facility 101 is represented as arriving at facility 101 via a satellite receiver 112 and is labeled Satellite Programming. Facility 101 receives programming from various sources and makes the content available to users 104a-n according to subscription packages.

Network 100 has a network interconnect facility 103 connected thereto and adapted to enable content being broadcast over network 100 to also be broadcast to other network segments. In this way specified content can be delivered to a plurality of connected networks covering a very large geographical region.

In a preferred embodiment of the present invention, each set-top box at each user location 104a-n has a content sharing module 109 provided thereto in the form of an integrated piece of hardware built into each box. In one embodiment hardware module 109 may be provided as an accessory device that can be connected to a set-top box like boxes 114.

Module 109 is adapted to accept data input from a media capture device like media capture devices 105a-105c illustrated in this embodiment at user locations 104a, 104e, and 104n. Media capture device 105a-n is a digital camera in a preferred embodiment, but may also be a multi-data format device like a video camera and picture recorder. Photo devices 105a-c are connected in this example, to respective modules 109 by way of output plug-in cables typically provided and adapted to enable content viewing and content recording (VCR) of content sourced from a peripheral device. Such cables typically have three connectors, two for audio and one for video. In current art, such cables are connectable directly to a television, a video recording unit (VCR), a set-top box, or directly to a digital video device (DVD) player. The other end of the cable is typically a single jack output connector hooked into the output-to TV of the camera or media capture device. Depending on a users configuration of an existing entertainment system, any of the included devices may be used as a first input device for accepting content from a device such as device 105, or as an output device for transferring content to device 105 (appropriate cable required).

In typical use without the module 109 of the present invention, a user wishing to view a slide show for example displaying pictures stored in memory of device 105 would simply connect the cable for output from device 105 to input to, in this case, set top box 114 and tune the television to display the slide show of pictures played from the media capture device. Virtually all types of media capture devices represented by device 105 have this capability. The pictures play in a timed fashion on television 115 in a full screen and color format. Therefore telivision 115 becomes a display unit for displaying content stored on device 105.

In use of the present invention a user such as any of users 105a-c having content for display (typically pictures in slide-show format) can instead of connecting to set-top box 114 or directly to television 115, can connect directly to module 109 for the purpose of sharing the content display with one or more users connected to network 100.

Module 109 functions to split a live picture display causing a version of the display to be sent to server 106 over a back-channel provided in cable trunks 102. At server 106, the content is relayed to a specified user or users to display on their respective televisions. In one embodiment of the present invention, server 106 is adapted to optionally record the content being transmitted thereto and store the content as, in this case, picture data to be delivered at a later time to any selected users having connection to network 100. In this embodiment, server 106 stores transmission data in digital format in a picture storage (P.S.) repository illustrated herein as repository 107 connected to server 106 by a data line. Repository 106 can be an optical disc or other type of digital storage facility such as magnetic hard drive.

In this embodiment a user targeted for receipt of content may receive a notification when they turn on their cable system that there is content waiting to be viewed. The user may then turn to a special channel and receive the slide-show display in the same manner that it was played from device 105. It is noted herein that actual picture files do not have to be transmitted in a recoverable format for an end user to view the display. The system of the invention “extends” the display to include selected televisions having connection to the network. However, a recipient may, of course record the active display session using a VCR similar to the way other broadcast channel content may be recorded.

In order to select users for receipt of a particular content session, a user with a media capture device such as device 105 connected to their system through device 109 can using the remote control of the cable system “order” and configure the send parameters using a send application 116 provided as part of module 109 or as a distributed application to set-top box 114. Using the remote, a user can identify the intended recipient or recipients by programming their telephone numbers and area codes into a send order and tag the identification data to the sent data.

Server 106 has a list server application 110 installed therein as part of the service software of the present invention. The list server application matches the telephone numbers of designated recipients to their system ID numbers and service plan information. Server 106 also has a schedule notification application 111 installed therein as part of the service software of the present invention. Application 111 keeps a list of all of the users (104) that are scheduled to receive a particular transmission of data. When the users turn on their systems, they are notified of their particular scheduled receipt of content. At that time they may tune to a special channel to receive the content, or may elect to reject the content.

Device 109 is capable of transmitting a “display” in real time as the display is created at a user location. For example, user 104a is executing a display for back channel transmission to, for example user 104d, which may be a relative. If user 104d is at home at the time of the display execution, a telephone call prior to display execution can be made by user 104a to inform the intended recipient of the pending action so that person can tune their system to receive the transmission. It is noted herein that in a preferred embodiment all display executions are received at office 101 and are relayed to the intended recipients.

In another embodiment of the present invention, server 106 is capable of recording the transmission and saving the transmission data as for re-broadcast at a later time time. In this embodiment, the intended recipient need not be pre-notified of a pending execution. Rather, the next time that that person is detected to be on the network and active, a notification can be delivered to that subscriber informing them of the content waiting. The notification can be sent and displayed on the users system as a pop-up message or as an item appearing on the user's television programming guide. The notification can be audio, video, or text, or any combination thereof Using the apparatus of the invention, people who are related or who are friends can share important picture and, in some embodiments, video content over large geographic spans as long as the sender and receiver are both subscribed in good standing to a cable service participating in the provided service. A grandmother for example, that cannot make a graduation of one of their grand children, for example, can receive a slide-show presentation of the graduation moments after it has occurred by simply tuning into a special “picture” channel provided as part of the service. The slide-show execution and transmission can be made as soon as the pictures are on the memory of the camera and the camera is plugged in to the source system.

In a preferred embodiment, the method and apparatus of the invention is practiced by a number of competing cable networks through interconnection facilities that can bridge subscribers of disparate networks. In this way it is not absolutely required that participants belong to a same brand of cable service as along as the service company they belong to supports the service.

One huge advantage of the system of the present invention is that it eliminates all of the work and risk of sending actual pictures over a computer network vulnerable to viruses, hackers, and unscrupulous observers. In one embodiment, a particular executed session can occur simultaneously with a telephone call so that the participants may communicate with one another verbally while a session transmission occurs.

In still another embodiment, the remote control unit may be used to annotate specific pictures in the presentation before it is executed for send. For example, a user may first play a slide show and pause on each picture wherein text annotation is associated with the paused picture by virtue of numeric relationship between created annotations and pictures in the slide presentation. Any pictures not intended for annotation can be annotated with “n/a” or “none” so that server 106 can match the annotation order with the right picture order. The result is that when the display execution is configured for “send”, the annotations can be caused to appear in a special annotation bar beneath a displayed picture at the receivers end or overlaid on the presentation display. Likewise, the timing of the show can be adjusted by frame insertion so that the slide show can be slowed to enable enough time for the receiver to read the annotations. The receiver of any particular display may also elect to record the display on videotape or DVD (if equipped) for later repeat viewing of the session from a tape or from DVD.

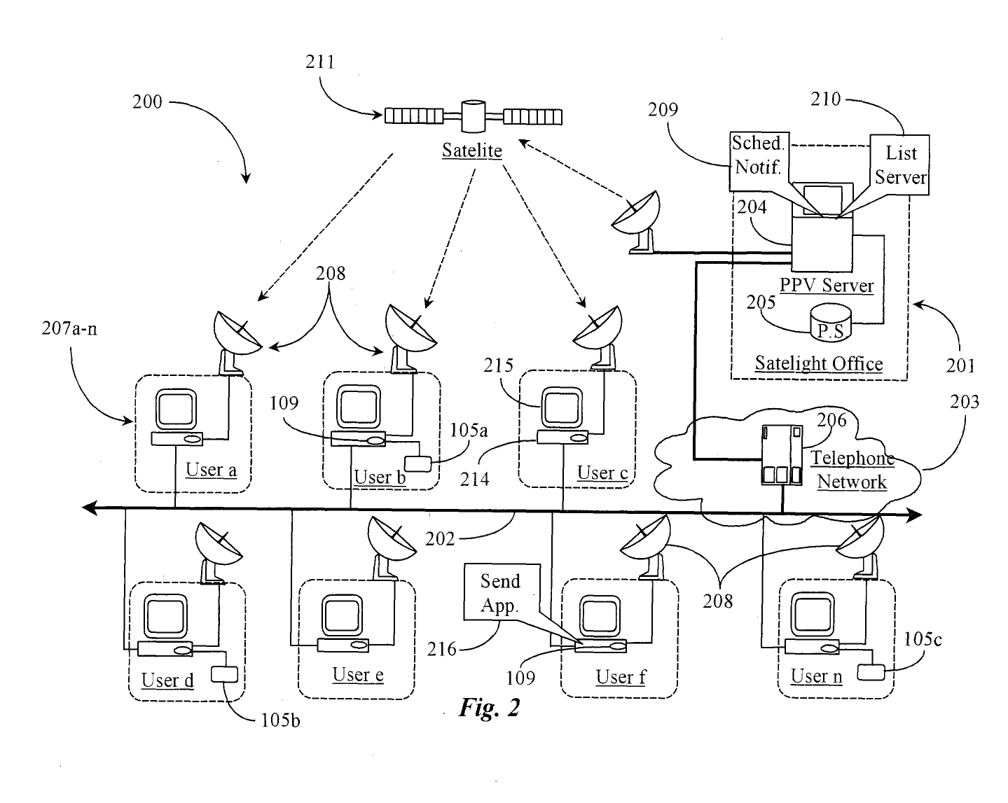

FIG. 2 is an architectural overview of a televising satellite network 200 adapted for picture sharing according to an embodiment of the present invention. Network 200 is similar in many respects to cable network 100 except for method of content delivery, which is via a satellite relay 211 in this example. Satellite television networks like network 200 are typically larger and geographically more far reaching that cable networks like network 100. However the methods of subscription and content ordering are largely the same.

Network 200 comprises a satellite office facility 201, which receives content programming and delivers the content to customers by beaming the content to a satellite 211, which then broadcasts the content to users 207a-n. In this case users 207a-n have a satellite receiver (dish) (208) connected to a set-top box (214) that is connected to a television 215. Typically the satellite dish has connection to the set top box via a coaxial cable connected to he dish and to the box. In a satellite network the receiving dishes 208 cannot transmit data so there is no back channel that can be used for “picture sharing”. The present invention solves this by using the telephone connection of the user as a back channel for transmitting data.

Satellite office 201, like cable office 101 has a server 204 provided therein and adapted to practice the present invention. Server 204 may be a PPV server as previously described with respect to sever 106 of FIG. 1 above. Server 204 may also be a separate server dedicated solely to the practice of the present invention. Module 109 functions essentially the same as that described with reference to FIG. 1 above. The difference between the two embodiments is that the executed sessions are transmitted over a telephone connection then relayed via satellite. For example, server 204 has a telephone connection to a telephony switch 206 illustrated in a telephone network 203. Network 203 is typically the public switched telephone network (PSTN), but may also be another type of telephone network.

Users 207a-n receive all of their content via satellite 211 through CPE system including dish receivers 208 one installed at each user location. It will be noted herein that some users will have more than one set top box as part of their CPE, both systems using a single dish to receive programming. In this case, there may be two modules 109 provided as part of the CPE or as accessories. Media capture devices 105a-c are illustrated at user locations 207b, 207c, and 207n respectively. All users subscribing to services offered through network 200 are connected to server 204 via telephony trunking 202 of network 203 through switch 206 and the trunk leading from switch 206 to server 204. Therefore all of the users 207a-n have their telephone lines connected to their set-top boxes as a back channel used for system testing, control, and for ordering on-demand Pay-per-view services.

A user for example, user 207n having camera 105c ready for display execution can specify recipients by telephone number identification as previously described. Server 204 has a “picture storage” repository 205 connected thereto and adapted for recording and storing transmissions that are “scheduled” for broadcast. A list server 210 provides identification of network subscribers that also subscribe to “picture sharing” services. A schedule notification server 209 is provided for sending alerts to those users that have content waiting for delivery.

It will be apparent to one with skill in the art that the method and apparatus of the present invention can be used in a cable or satellite network for relaying a live presentation between users wherein the central server analogous to servers 106 and 204 of FIGS. 1 and 2 respectively, relays a live transmission of picture content as in a slide show presentation so as to render the presentation viewable on the receiving system. In this aspect the central server functions as a proxy for relaying the transmission in real time. Moreover, the system can record sessions executed from the original source memory and store the recorded sessions for broadcast according to schedule.

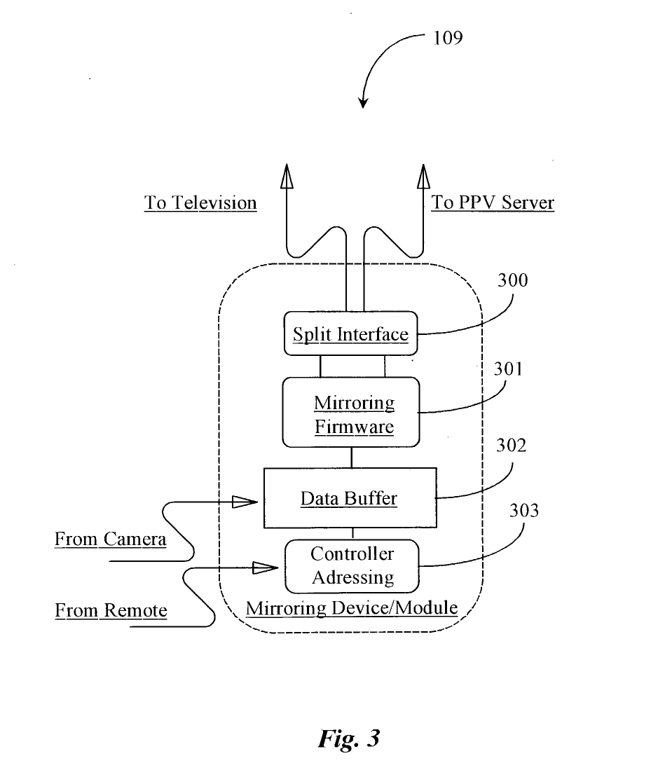

FIG. 3 is a block diagram illustrating picture-sharing module 109 of FIGS. 1 and 2 according to an embodiment of the present invention. Module 109 can be an integrated hardware to a cable or satellite set-top-box. In another embodiment, module 109 is a separate mechanism that connects to a set-top-box via cable connection.

Module 109 has a controller and addressing module 303 provided therein that is adapted for programming recipients for content delivery and for controlling the other functions of module 109. Controller 303 is adapted to receive instruction from a remote control device. A user operation a remote control, which can be the set-top-box system controller, can program recipients of shared content by entering the recipients' telephone number before executing a content display action. Module 109 takes wireless input from a system remote for the purpose of configuring a content share session. For example, the intended recipient(s) can be identified and the timing of a presentation can also be identified. If a slide show for example is programmed automatically to run every 2 seconds from the camera, the transmission to the central server can be timed to execute slower than the original presentation.

Data such as recipient ID, number of slides in a presentation, and timing between individual slides is tagged to a content sharing order that is handled much like a pay-per-view order of a movie. The data accompanies the actual content data to the central server where it is interpreted and validated before relay to the intended recipient.

Module 109 has a data buffer 302 provided therein and adapted for the purpose of buffering content and programming data from a connected camera or other media capture device and the system remote. Data buffer 302 may be a volatile flash memory that does not retain data after the system is powered off. In one embodiment, buffer 302 can be a system random access memory device capable of retaining data after power is disconnected from the system. Power to device 109 may vary according to implementation. For example, device 109 may be powered by alternating current (AC) separately from the host system. In another embodiment module 109 is powered by the host system as an interconnected device.

Buffer 302 has a mirroring firmware 301 provided thereto and adapted to copy content from a source memory such as a removable memory device or “stick” used with a media capture device. The memory size of buffer 302 may vary according to planned capacity, but is a least large enough for buffering several individual .jpegs that are being transmitted.

Firmware 301 provides a data stream for local display on a sender's telivision and an identical stream that is simultaneously propagated through a back channel of the cable or satellite system to the central server via a split interface 300 hardwired into the signal propagation paths. Module 109 is ported in line with local CRT display and to the system's designated back channel whether it is a reserved channel in the cable of the cable system through a cable modem or whether it is the user's telephone line (satellite system).

In one alternate embodiment with regard to the satellite example, receiving dishes of subscribing users may be provided a limited sending capability in their satellite receivers via a simple installation of appropriate apparatus thereby providing a back channel via satellite. In the case of a relay transmission, a user of module 109 may pre-qualify a recipient by first calling him or her on the telephone and directing them to a special channel designated for the purpose by the service provider. While the receiver is tuned to the special channel, the sender can execute a slide show presentation, for example, from a digital camera connected to module 109. At the service provider location, the transmission received through the back channel from the identified sender is parsed for recipient ID and validated as an authorized recipient before the transmission is relayed to that persons receiver system. It is noted herein that there are sophisticated systems that allow rewind television (content recording in the background). One such system is TIVO™. Persons with such systems may receive programming including content sharing sessions directed to their receivers wherein the content or “slide show” is recorded automatically for later viewing as is the normal user selected content. In this embodiment a user simply includes the “picture channel” in with other recorded channels. There are many possibilities.

Picture sharing through cable and/or satellite systems opens a new market of consumers who do not have computers or Web-enabled set top boxes that have e-mail capabilities. No Internet service subscription or connection to a third party data network is required in order to practice the present invention.

A basic service model can be provided wherein all current subscribers are maintained in a subscribers database. The service model can be part of the normal service programming and offered as an extension to a basic cable package. Subscribers can receive their content over a designated pay-per-view channel and can pay by transmission received, or by a block of bandwidth reflecting a pre-ordered chunk of bandwidth of a size that diminishes to an extent for each transmission actually received. Module 109 can be easily integrated in to most standard set-top-box systems designed for HDTV, DTV, satellite TV, and so on.

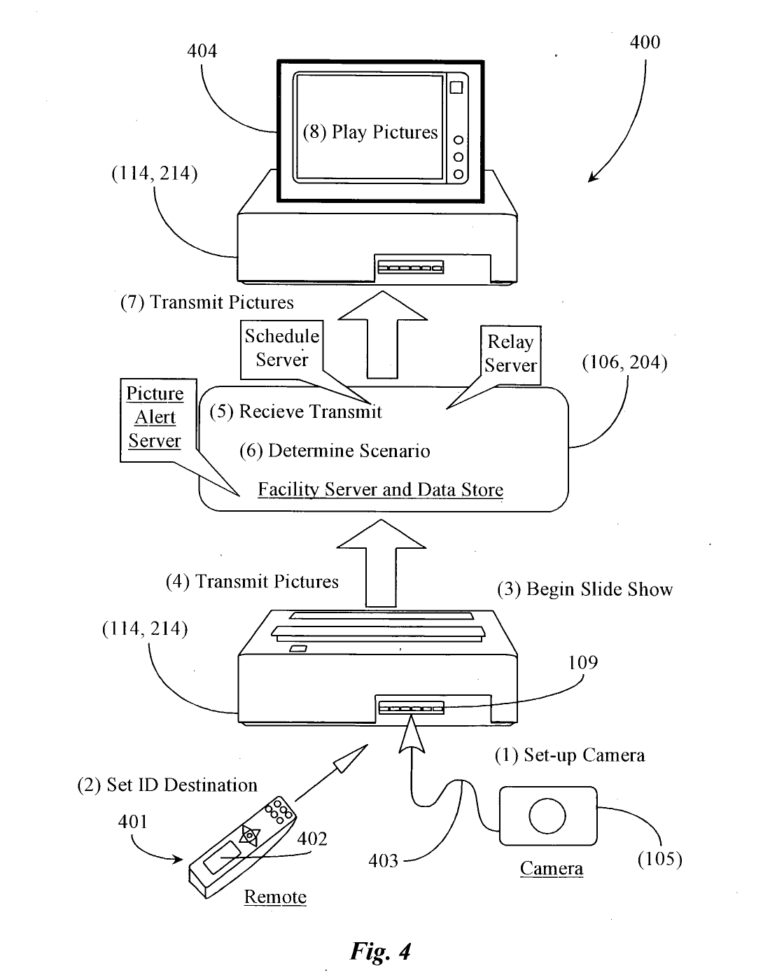

FIG. 4 is a block diagram illustrating steps for picture sharing according to an embodiment of the present invention. At step 1 a user wishing to execute a content sharing session sets up a camera (105) containing the pictures on memory for display presentation by connecting an output audio/video cable or a video cable 403 to an output jack of camera 105 and to the input jacks on device 109. At step 2, with the cable system powered on, the user programs one or more recipient identification numbers in a session order mode similar to ordering a pay-per-view movie. Additional programming may be initiated through the remote for configuring timing of the presentation meaning how many seconds between pictures in a slide show.

In one embodiment a slide presentation can be annotated from the remote control if the user adds a step for a test run so that each slide is executed serially and paused long enough to enter text description via the remote before un-pausing to display the next picture. After the entire test presentation has been annotated, the presentation can be sent with the annotation data timed to display in parallel with the slides at the receiving end. The system associates the annotations with the pictures by order of serial presentation of the slides to insure that the correct annotation is displayed with the correct slide.

At step 3 the sender executes the slide show from the camera or media capture device. At step 4, the set-top-box (114, 214) transmits the presentation over a back channel to the facility server (106, 204). It is noted herein that in a real-time relay, actual picture files are not transmitted but are simply displayed as would be the case on a local CRT or digital television screen except that the display line includes the facility as a relay point and the end recipient system as an additional display device. The display also runs locally on the senders system.

At step 5 the server receives the transmission from the sender and determines the order scenario (real time or scheduled), the ID of the recipient, and any other parameters programmed into the order before execution. In one embodiment, the transmission is buffered while the relay broadcast to the target end system or systems is achieved. In one embodiment, the transmission is recorded in case the recipient or recipients are not currently available and the presentation is to be scheduled. A limit of how many end systems may receive a display can be enforced so as not to overload a system with many participants.

At step 7 the relay server broadcasts the session, which is picked up by the receiving system or systems pre-designated as the authorized recipients. At step 8 the receiving system plays the session on television 404 in this example. The system is particularly suited to cable systems having adequate bandwidth in a back channel. Those system using telephone lines as the back channel will typically redirect the transmission over satellite to the recipients end receiver as would be the case for any programming. The system of the present invention may be practiced without an Internet connection, Internet service provider, or a computer. Participating networks can be linked via network interconnects (typically used to extend commercial programming) for practicing the present invention so that much larger geographic coverage can be realized.

1. A system for sharing a content display transmission sourced from a media capture device over a television network comprising:
a source node connected to the network, the source node including the media capture device storing the content for transmission;
at least one receiving node connected to the network;
a central server for brokering the transmission; and
a transmission splitting module integrated into the display path and into the back channel transmission path of the source node for rendering a second version of the display transmission;
characterized in that the display transmission is configured on the source node and physically executed from the media capture device connected to the source node, the device containing the content for display and wherein the transmission splitting module diverts a version of the display to be sent to the central server over a back channel of the system, the central server then ordering broadcast of the display transmission to the at least one receiving node over the network.

2. The system of claim 1 wherein the television network is a cable network.

3. The system of claim 1 wherein the telivision network is a satellite network.

4. The system of claim 1 wherein the transmission is a display transmission of a series of picture files organized in the form of a picture slide show.

5. The system of claim 1 wherein the transmission is a display transmission of a series of video frames organized as a compressed video.

6. The system of claim 1 wherein the source node including the media capture device and the at least one receiving nodes further comprise at least a television and a set-top-box.

7. The system of claim 1 wherein the network is a cable network and the back channel is a data path in the carrier cable.

8. The system of claim 1 wherein the network is a satellite network and the back channel is a telephone line.

9. The system of claim 1 wherein the central server contains a list sever for identifying subscribers and validating those subscribers for receiving a transmission.

10. The system of claim 1 wherein the central server is a modified pay-per-view server wherein the transmissions orchestrated there through are directed to subscribers over a special dedicated pay-per-view channel adapted for the purpose.

11. The system of claim 1 wherein the central server has notification software and causes alerts to be sent to receiving nodes over the network, the alerts notifying alerting subscribers of pending transmissions.

12. The system of claim 1 wherein the central server has access to a recording software for recording a display transmission and storing it for later broadcasting.

13. The system of claim 1 wherein a user operating the source node via a remote control configures a transmission for execution including identification of intended recipients.

14. The system of claim 1 wherein a user operating the source node configures a transmission for execution including identification of intended recipients using a telephone.

15. The system of claim 6 wherein the transmission display splitting module is integrated into the set-top-box.

16. The system of claim 6 wherein the transmission display module is a separate unit and cabled to the set-to-box and cabled into the back channel.

18. A transmission display splitting module comprising:
a controller interfaced to a remote control device;
a buffer for buffering data;
a firmware for mirroring data; and
a splitter for directing mirrored data on two paths, characterized in that the module causes an identical version of a display transmission sourced from a media capture device connected to a node on a television network to be sent over a back channel of the node to a central server to be redirected to display on a receiving node connected to the network.

19. The module of claim 18 wherein the module is integrated into a set-top-box connected to the network.

20. The module of claim 18 wherein the module is separate and cabled to the set-top-box for local display and to the back channel.

21 The module of claim 18 wherein the network is a cable network and the back channel is a data channel in a carrier cable.

22. The module of claim 18 wherein the network is a satellite network and the back channel is a telephone line.

23. The module of claim 18 powered by a separate AC outlet.

24. The module of claim 19 powered by AC through the set-top-box.

25. On a television network, a method for causing a display transmission sourced from a media capture device connected to a source node to be shared with a designated receiving node the shared version sent from the source node over a system back channel to a central server and then over network paths to the receiving node, the source and receiving node both connected to the television network comprising:
(a) connecting the media capture device to a data input of the source node;
(b) pre-configuring and ordering the sharing session; and
(c) executing the display transmission from the media capture device.

26. The method of claim 25 wherein in step (a) the media capture device is a digital camera.

27. The method of claim 25 wherein in step (a) the media capture device is a video capture device.

28. The method of claim 25 wherein in step (b) pre-configuring and ordering is performed by a remote control.

29. The method of claim 25 wherein in step (b) pre-configuring and ordering is performed through a telephone.
